(19) United States
(12) Patent Application Publication
(10) Pub. No.: US 2013/0254132 A1
(43) Pub. Date: Sep. 26, 2013

(54) Unified Service for Providing Shipping Services

(71) Applicants: Badrinath Vengalathur Srinath, Chennai TamilNadu (IN); Mohit Soni, Jaipur (IN); Madusudanan Rengasamy, Chennai (IN)

(72) Inventors: Badrinath Vengalathur Srinath, Chennai TamilNadu (IN); Mohit Soni, Jaipur (IN); Madusudanan Rengasamy, Chennai (IN)

(73) Assignee: eBay Inc., San Jose, CA (US)

(21) Appl. No.: 13/677,095

(22) Filed: Nov. 14, 2012

(30) Foreign Application Priority Data
Mar. 26, 2012 (IN) 876/DEL/2012

(51) Int. Cl. G06Q 10/08

(52) U.S. Cl. CPC G06Q 10/0834
USPC 705/334

(57) ABSTRACT

A system, method, and computer readable medium is provided to provide a publisher with a single interface to a plurality of shipping service providers. To begin, the method may receive, through a message bus, a request event message sent by the publisher. The request event message may include a shipping service provider identifier. Next, the method may identify a shipping interface based on the shipping service provider identifier, where the shipping interface corresponds to a shipping service provider of the plurality of shipping service providers. The method may then send, using the shipping interface, a shipping service request to the shipping service provider, with the shipping service request corresponding to a shipping service provided by the shipping service provider.

### PRIORITY CLAIM

This application claims the benefit of priority under 35 U.S.C. §119 of Indian Provisional Patent Application Serial Number 876/DEL/2012, entitled “UNIFIED SERVICE FOR PROVIDING SHIPPING SERVICES,” filed on Mar. 26, 2012 (Attorney Docket No. 2043.A.30IN1/P14191N1), which is incorporated by reference herein in its entirety.

### TECHNICAL FIELD

This application relates to data processing. In particular, example embodiments may provide a unified interface for performing shipping services across shipping service providers.

### BACKGROUND

in a typical business transaction, a buyer and seller may negotiate terms regarding the delivery of an item. Delivery of an item usually involves one party (e.g., the buyer or the seller) contacting a shipping service provider, exchanging information with the shipping service provider, and then agreeing on shipping arrangements, such as item pickup, delivery requirements (e.g., timeframe), costs, and the like. However, where the buyer or seller is involved in a number of transactions involving, say, for example, parties with varying needs (e.g., such as delivery times, costs, locations, and so on), fulfilling such delivery terms may potentially involve dealing with many different shipping service providers, each with a different protocol.

### BRIEF DESCRIPTION OF THE DRAWINGS

Example embodiments are illustrated by way of example, and not by way of limitation, in the figures of the accompanying drawings in which:

FIG. 1 is a network diagram depicting a transaction system, according to one example embodiment, having a client-server architecture configured for exchanging data over a network;

FIG. 2 is a network diagram depicting an event driven system, according to an example embodiment, that is configured to exchange event messages according to a subscription model;

FIG. 3 is a block diagram illustrating exemplary modules of the shipping capability shown in FIG. 2, consistent with an example embodiment;

FIG. 4 is a flow chart diagram illustrating a method of initializing an event system to provide a unified interface to multiple shipping service providers, according to an example embodiment;

FIG. 5 is a diagram illustrating example shipping request topics that may be subscribed to by the listener port, in an example embodiment;

FIG. 6 is a diagram illustrating example shipping response topics that may be subscribed to by a publisher;

FIG. 7 is a flow chart diagram showing a method of utilizing a unified interface to provide shipping services associated with multiple shipping service providers, according to an example embodiment;

FIG. 8 is a block diagram illustrating example applications and/or services which are provided as part of the network based publisher, according to some embodiments; and

FIG. 9 shows a diagrammatic representation of machine in the example form of a computer system within which a set of instructions may be executed causing the machine to perform any one or more of the methodologies discussed herein.

### DETAILED DESCRIPTION

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

A system, method, and computer readable medium is provided to provide a publisher (e.g., a commerce application) with a single interface to a plurality of shipping service providers. To begin, the method may receive, through a message bus, a request event message sent by the publisher. The request event message may include a shipping service provider identifier. Next, the method may identify a shipping interface based on the shipping service provider identifier, where the shipping interface corresponds to a shipping service provider of the plurality of shipping service providers. The method may then send, using the shipping interface, a shipping service request to the shipping service provider, with the shipping service request corresponding to a shipping service provided by the shipping service provider.

Providing a publisher with a single interface to a plurality of shipping service providers may find many practical applications. In some embodiments, the single interface simplifies the operation of the publisher, as the publisher invokes operations provided by the many shipping service providers through a single interface. In this way, the processing logic of the publisher may be substantially simplified as the publisher does not have to support many different protocols.

These and other example embodiments are disclosed in greater detail below.

### Platform Architecture

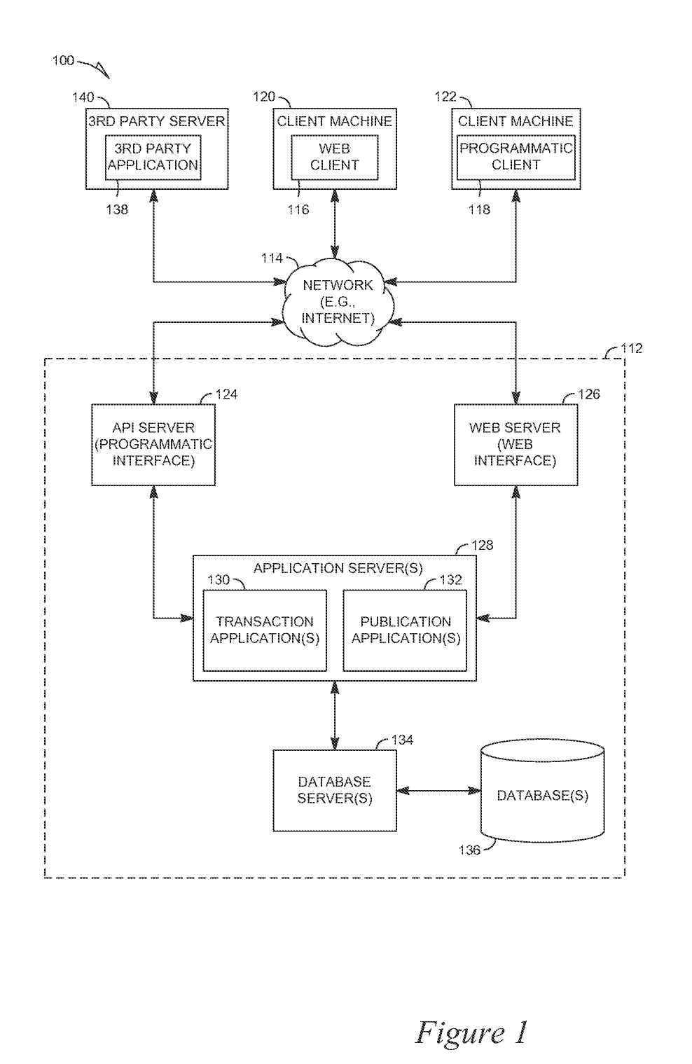

FIG. 1 is a network diagram depicting a transaction system 100, according to one embodiment, having a client-server architecture configured for exchanging data over a network. The transaction system 100 may be a publishing system where clients, through client machines 120, 122 and a third party server 140, may communicate, view, search, and exchange data with network based publisher 112. For example, the transaction system 100 may include various applications for interfacing with client machines and client applications that may be used by users (e.g., buyers and sellers of the system to publish items for sale in addition to facilitating the purchase and shipment of items.

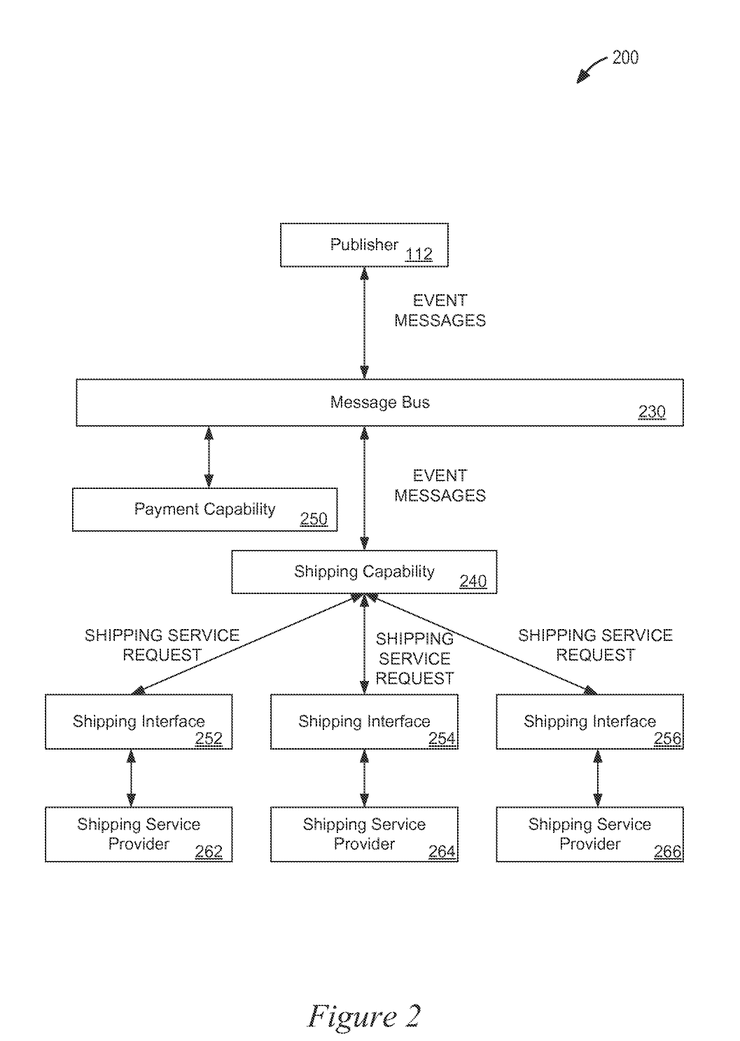

The network based publisher 112 may provide server-side functionality, via a network 114 (e.g., the Internet) to one or more clients. The one or more clients may include users that utilize the network based publisher 112 as a transaction intermediary to facilitate the exchange of data over the network 114 corresponding to user transactions. User transactions may include receiving and processing item and item related data and user data from a multitude of users, such as payment data, shipping data, item review data, feedback data, and so forth. A transaction intermediary such as the network based publisher 112 may include one or all of the functions associated with a shipping service broker, such as payment services and other functions associated with transactions between one or more parties. For simplicity, these functions are discussed as being an integral part of the network based publisher 112; however, it is to be appreciated that these functions may be provided by transaction systems remotely, and/or decoupled, from the network based publisher 112. Examples of such remote or decoupled systems are described below with reference to FIG. 2.

In various embodiments, the data exchanges within the transaction system 100 may be dependent upon user selected functions available through one or more client/user interfaces (UIs). The his may be associated with a client machine, such as the client machine 120, utilizing a web client 116. The web client 116 may be in communication with the network based publisher 112 via a web server 126. The UIs may also be associated with a client machine 122 utilizing a client application 118, or a third party server 140 hosting a third party application 138. It can be appreciated that in various embodiments the client machine 120, 122 may be associated with a buyer, a seller, a payment service provider, or a shipping service provider, each in communication with the network based publisher 112 and optionally each other. The buyers and sellers may be any one of individuals, merchants, and the like.

With continued reference to FIG. 1, the network based publisher 112 may include data exchange functions to communicate information relating to shipping items or goods. In one embodiment, these functions allow a party to a transaction (e.g., a merchant or consumer) to communicate payment and shipping data through a unified interface which is then utilized to coordinate shipping services provided by one of a number of shipping providers. The shipping data may include data relating to shipping labels, tracking data, return data, and the like. Such shipping data may in turn be processed by a shipping service provider (e.g., FEDERAL EXPRESS®, etc.) to perform shipment related functions.

Turning specifically to an embodiment of the network based publisher 112 architecture, an application program interface (API) server 124 and a web server 126 are coupled to, and provide programmatic and web interfaces respectively to, one or more application servers 128. The application servers 128 host one or more transaction applications 130 and publication applications 132. The application servers 128 may be coupled to one or more database servers 134 that facilitate access to one or more storage devices, such as the database 136.

The transaction applications 130 may provide a number of payment processing modules to facilitate processing payment information associated with a buyer purchasing an item from a setter. The publication applications 132 may include various modules to provide a number of publication functions and services to users that access the network based publisher 112. For example, these services may include, inter alia, formatting and delivering search results to a client. The shipping applications may include various modules to provide a number of shipping functions and services to the buyer and seller alike, such as, for example, offering a unified interface to manage aspects of shipping across different shipping service providers.

FIG. 1 also illustrates an example embodiment of a third party application 138, which may operate on a third party server 140 and have programmatic access to the network based publisher 112 via the programmatic interface provided by the API server 124. For example, the third party application 138 may utilize various types of data communicated with the network based publisher 112 and support one or more features or functions normally preformed at the network based publisher 112. For example, the third party application 138 may receive a copy of all or a portion of the data storage 136 that includes buyer shipping data and act as the transaction intermediary between the buyer and seller with respect to functions such as shipping and payment functions. Additionally, in another embodiment, similar to the network based publisher 112, the third party application 138 may also include modules to perform operations pertaining to payment, shipping, and the like. In yet another embodiment, the third party server 140 may collaborate with the network based publisher 112 to facilitate transactions between buyers and sellers, such as by sharing data and functionality pertaining to payment, shipping, and the like. Examples of third party applications 138 may include shipping service providers that provide such shipping services as printing labels, shipping insurance, tracking, returns, and the like.

Aside from using a client-server architecture, some embodiments may utilize distributed event driven architectures. For example, FIG. 2 is a network diagram depicting an event driven system 200, according to an example embodiment, that is configured to exchange event messages according to a subscription model. The event driven system 200 may include the publisher 112 of FIG. 1 (or one or more additional publishers) communicatively coupled to a shipping capability 240 through a message bus 230.

The message bus 230 may be a network addressable computer system that exchanges event messages between capabilities according to a subscription model. A “capability,” as used herein, may refer to a web-service that is configured to receive (subscribe) and send (publish) event messages through the message bus 230. An event message may specify a service that is to be performed. (referred to herein as a request event message) or may specify a result of performing a service (referred to herein as a result event message). In some embodiments, an event message may include a topic and a payload. In some embodiments, the topic may be data (e.g., an alpha-numerical identifier) that specifies, in the case of a. request event message, a service which is being requested or, in the case of a result event message, a service that has been performed. The payload may be data that is usable to perform a service or to identify a result specified by the topic of the event message.

As described above with reference to FIG. 1, the publisher 112 may be a transaction intermediary that provides clients with functions associated with a shipping service broker, payment service, and other functions associated with transactions between one or more parties. For example, the publisher 112 may be MAGENTO®, a virtual storefront application provided by EBAY®. Using the publisher 112, client machines (e.g., client machines 120 and 122 of FIG. 1) may request, for example, a shipping service (e.g., a shipping label) to be performed in connection with a transaction facilitated by the publisher 112.

The shipping capability 240 may be a web-service that provides a unified interface layer over one or more shipping service providers 262, 264, 266. In some embodiments, the shipping capability 240 receives a shipping service request in one format (e.g., a request event message), translates the shipping service request into a format specific to a particular shipping service provider, and sends the translated shipping service to the particular shipping service provider.

The payment capability 250 may be a web-service that provides a payment services usable to pay for shipping services provided by the one or more shipping service providers 262, 264, 266.

Consistent with embodiments described herein, the shipping service providers 262, 264, 266 may each be network addressable computers hosted by different organizations. The shipping service providers 262, 264, 266 may perform a shipping service (e.g., generating a shipping label, calculating a shipping rate, and any other suitable service) in response to receiving a shipping service request via shipping interfaces 252, 254, 256, respectively. It is to be appreciated that each of the shipping interfaces 252, 254, 256 may differ from each other. For example, in some embodiments, the shipping interface 252 and the shipping interface 254 may each expose an API usable to request a shipping label, but they may each specify different API signatures (arguments, data types, protocols, etc). Further, in some embodiments, a shipping service provider (e.g., the shipping service provider 266) may lack direct support for such label printing functionality. In some embodiments, when a shipping service provider and its corresponding shipping interface do not expose a particular shipping function or web service, the shipping capability 240 may perform such a service on behalf of the shipping service provider. For example, in the case of printing labels, the shipping capability 240 may maintain a pool of the labels that may be sent back to a user for printing.

It is to be appreciated that the publisher 112 may use the message bus 230 and the shipping capability 240 to send shipping service requests to any number of shipping service providers. However, rather than generating shipping service requests specific for any one of the many possible shipping interfaces, the publisher 112 merely formats an event message that conforms to the shipping capability 240. In turn, upon receiving the event message, the shipping capability 240 may use the received event message to interact with a given shipping service provider, in this way, the shipping capability 240 provides, to the publisher 112, a single, unified interface for interacting with many shipping service providers.

### Exemplary Modules

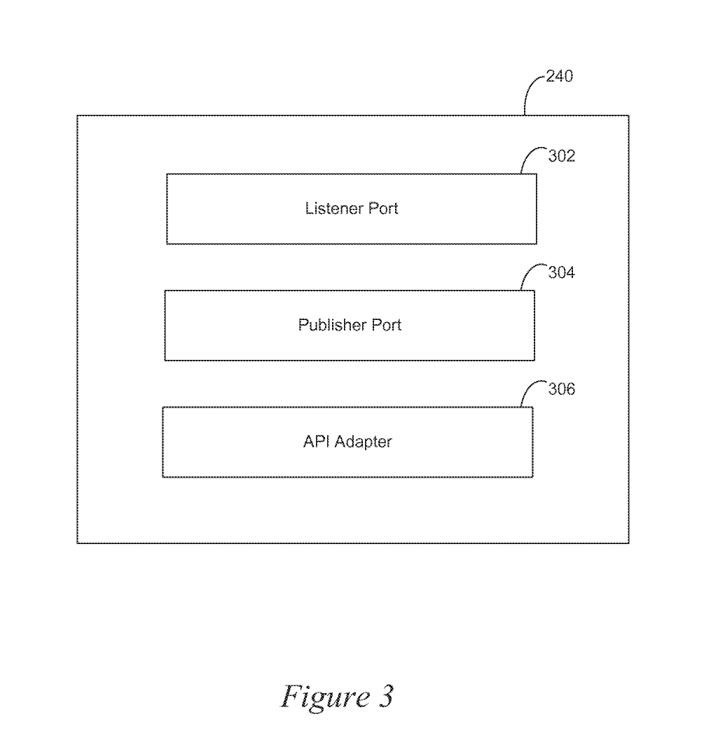

The shipping capability 240 of FIG. 2 is now described in greater detail. FIG. 3 is a block diagram illustrating exemplary modules of the shipping capability 240 shown in FIG. 2, consistent with an example embodiment. As FIG. 3 shows, the shipping capability 240 may include a listener port 302, a publisher port 304, and an API adapter 306.

The listener port 302 may be a computer-implemented module configured to perform operations relating to subscribing to, and receiving request event messages published by, the publisher 112.

The publisher port 304 may be a computer-implemented module configured to perform operations relating to publishing response event messages through the message bus 230 that are, in turn, received by the publisher 112.

The API adapter 306 may be a computer-implemented module configured to perform operations relating to translating event messages conforming with an event message format to a shipping service request that conforms o a particular shipping service provider. Further, the API adapter 306 may be configured to transform data from a shipping service response that conforms to an API specified by a particular shipping interface to a response event message that conforms with an event message format. Still further, in some embodiments, the API adapter 306 may perform one or more operations on behalf of a shipping service provider (e.g., maintain a pool of shipping labels, distribute shipping labels, etc).

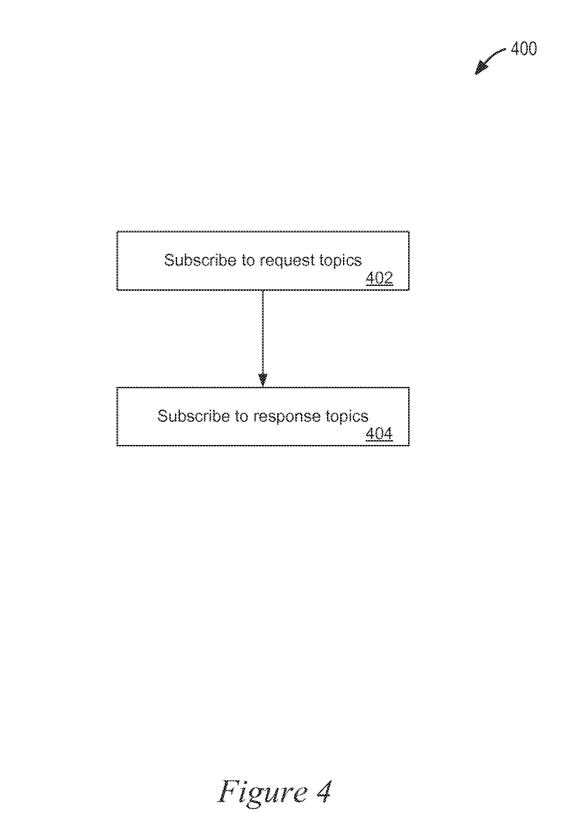

The operations performed by the listener port 302, the publisher port 304, and the API adapter 306 are described in greater detail with reference to FIGS. 4-7.

### Exemplary Methods

As described above, an example embodiment may involve communication between the publisher 112 and the shipping capability 240 through an event driven architecture (see, e.g., the event driven system 200 of FIG. 2). FIG. 4 is a flow chart diagram illustrating a method 400 of initializing an event system to provide a unified interface to multiple shipping service providers, according to an example embodiment. As FIG. 4 shows, the method 400 may begin at operation 402 when the listener port 302 sends a request to the message bus 230 to subscribe to a shipping request topic. For example, the listener port 302 may communicate with the message bus 230 to subscribe to a shipping request topic associated with a shipping service (e.g., printing shipping labels) that is provided by one or more shipping service providers. In some embodiments, when the message bus 230 subscribes the listener port 302 to a shipping request topic, the message bus 230 may associate a network usable address of the listener port 302 with the shipping request topic. Such an association allows the message bus 230 to route request event messages to the listener port 302 when the request event message includes a shipping request topic that matches the shipping request topic to which the listener port 302 subscribes. Still further, in some embodiments, the listener port 302 subscribes to the shipping request topics on behalf of a capability or a merchant. Accordingly, operation 402 may involve the listener port 302 communicating authentication tokens associated with a user to authenticate and authorize the receipt of event messages.

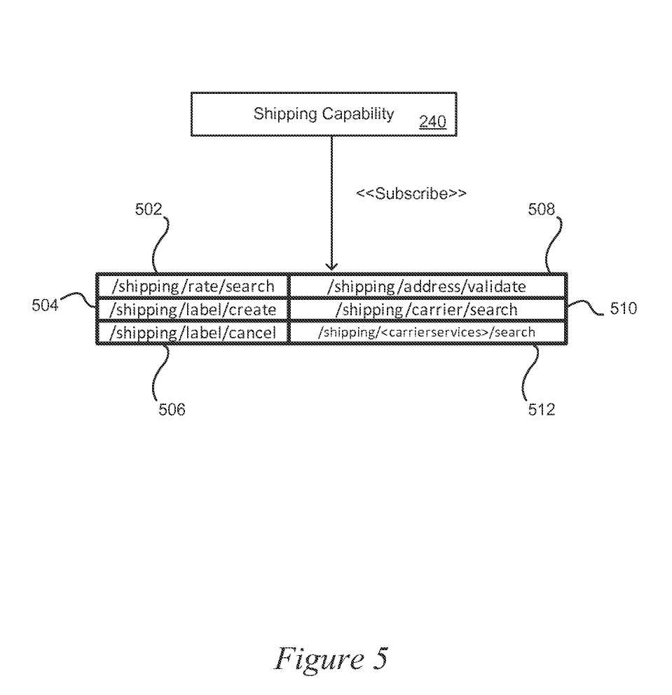

FIG. 5 is a diagram illustrating example shipping request topics that may be subscribed to by the listener port 302, in an example embodiment. For example, the listener port 302 may subscribe to a “/shipping/rate/search” shipping request topic 502 that corresponds to a request to search for shipping rates for a given shipment. The listener port 302 may also, in some embodiments, subscribe to a “/shipping/label/create” shipping request topic 504 that corresponds to a request to create a shipping label for a specified shipment. The listener port 302 may also, in some embodiments, subscribe to a “/shipping/label/cancel” shipping request topic 506 that corresponds to a request to cancel a label associated with a specified tracking number. The listener port 302 may also, in sonic embodiments, subscribe to a “/shipping/address/validate” shipping request topic 508 that corresponds to a request to validate a specified address. The listener port 302 may also, in some embodiments, subscribe to a “/shipping/carrier/search” shipping request topic 510 that corresponds to a request to return a list of shipping service providers supported by the shipping capability 240.

It is to be appreciated that the shipping request topics shown in FIG. 5 are merely provided for the purpose of illustration and not limitation. Those skilled in the art will appreciate that other embodiments may provide more or less shipping request topics in any suitable format.

With reference back to FIG. 4, operation 404 involves the publisher subscribing, with the message bus 230, to shipping response topics.

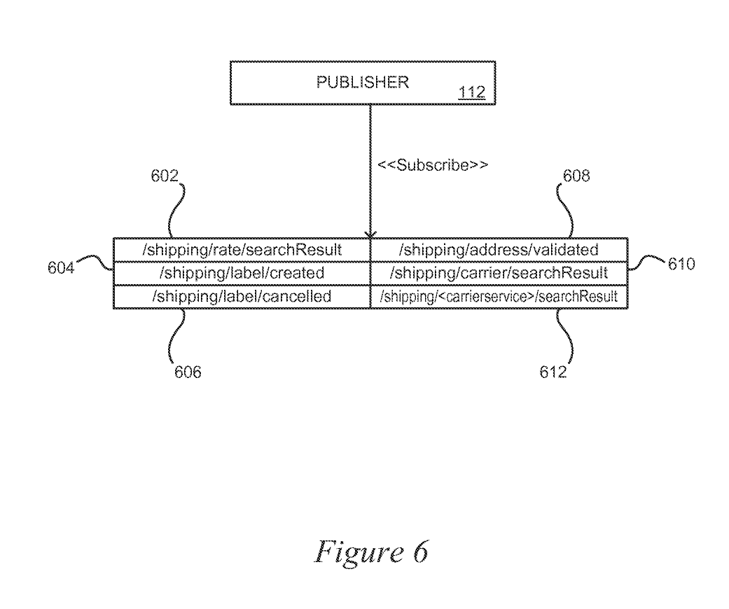

FIG. 6 is a diagram illustrating example shipping response topics that may be subscribed to by the publisher 112. For example, the publisher 112 may subscribe to a “/shipping/rate/searchResult” shipping response topic 602 that indicates that an event message includes results to a request to search for shipping rates for a given shipment. The publisher 112 may also, in some embodiments, subscribe to a “/shipping/label/created” shipping response topic 604 that indicates that an event message includes results to a request to create a shipping label for a specified shipment. The publisher 112 may also, in some embodiments, subscribe to a “/shipping/label/cancelled” shipping response topic 606 that indicates that an event message includes results to a request to cancel a label associated with a specified tracking number. The publisher 112 may also, in some embodiments, subscribe to a “”shipping/address/validated” shipping response topic 608 that indicates that an event message includes results to a request to validate a specified address. The publisher 112 may also, in sonic embodiments, subscribe to a “/shipping/carrier/searchResult” shipping response topic 610 that indicates that an event message includes results to a request to return a list of shipping service providers supported by the shipping capability 240. The publisher 112 may also, in some embodiments, subscribe to a “/shipping/carrierservice/searchResult” shipping response topic 612 that indicates that an event message includes results to a request to return a list of shipping services supported by a given shipping service provider.

It is to he appreciated that the shipping response topics shown in FIG. 6 are merely provided for the purpose of illustration and not limitation. Those skilled in the art will appreciate that other embodiments may provide more or less shipping request topics in any suitable format.

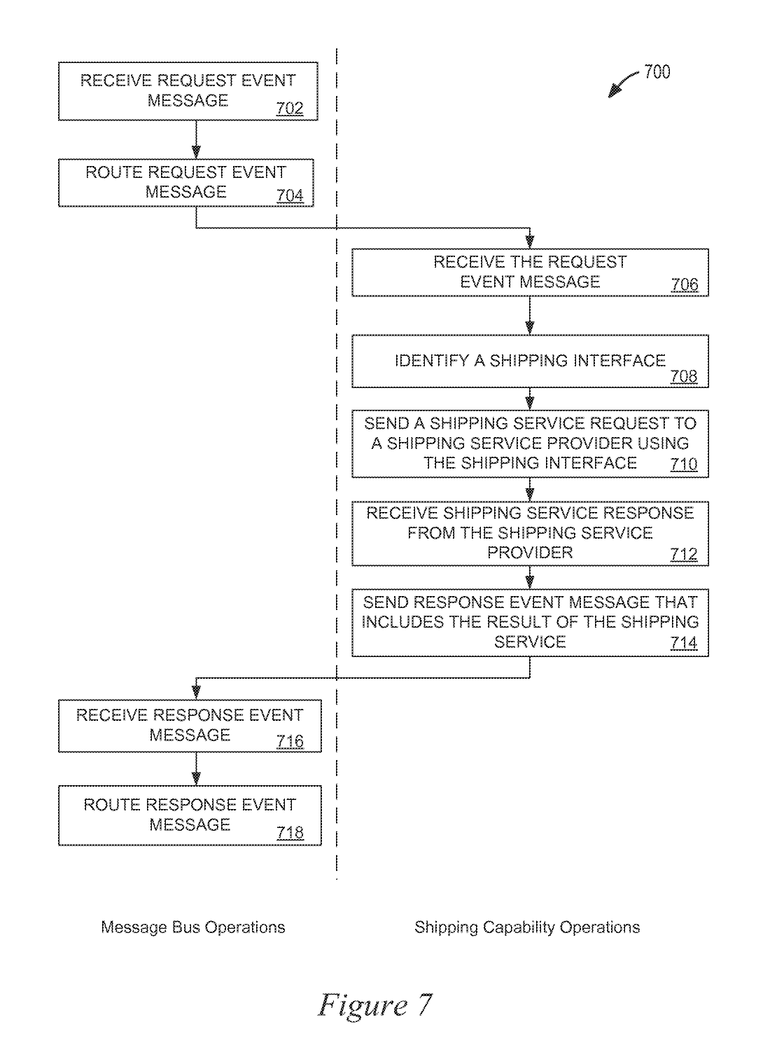

Once the publisher 112 and the shipping capability 240 have subscribed to shipping topics associated with one or more shipping services, the shipping capability 240 may begin providing a unified interface. To illustrate, FIG. 7 is a flow chart diagram showing a method 700 of utilizing a unified interface to provide shipping services associated with multiple shipping service providers, according to an example embodiment. As FIG. 7 shows, the method 700 may begin at operation 702 when the message bus 230 receives a request event message from the publisher 112. The request event message may be in a format specified by the message bus. For example, the request event message may include a shipping request topic associated with a shipping service provided by one or more shipping service providers, a shipping service provider identifier, and shipping data. For example, the request event message may include a “/shipping/label/create” shipping request topic, a shipping service provider identifier associated with FEDEX®, and shipping data specifying properties associated with a label, such as an account number, a destination address, a package weight, a priority, an indication of whether confirmation is desired, and the like.

Upon receiving the request event message, the message bus 230 may then route the request event message to the shipping capability 240, as shown in operation 704 in FIG. 7. As explained above, the message bus 230 routes the request event message to the shipping capability 240 based on the shipping capability 240 previously subscribing to the shipping request topic included in the request event message. For example, as discussed above with reference to FIG. 5, the listener port 302 may have previously subscribed to the “/shipping/label/create” shipping request topic. Consistent with some embodiments, the message bus 230 may perform additional or alternative determinations to determine that the listener port 302 is to receive the request event message. For example, the message bus 230 may validate (e.g., authenticate or authorize) a token assigned to a tenant, capability, or a combination thereof.

At operation 706, the listener port 302 receives, through the message bus 230, the request event message sent by the publisher 112.

At operation 708, the API adapter 306 may identify a shipping interface associated with the request event message previously received in operation 706. In some embodiments, the API adapter 306 may maintain a table or any other suitable data structure that maps shipping service provider identifiers to shipping interfaces. Accordingly, in example embodiments where the request event message includes a shipping service provider identifier, the API adapter 306 may match the shipping service provider identifier in the request event message with a shipping service provider identifier in the table to determine the shipping interface to use in requesting a shipping service.

At operation 710, the API adapter 306 sends a shipping service request to a shipping service provider using the shipping interface identified in operation 708. The shipping service request may be in a format specified by the identified shipping interface. For example, the shipping interface may specify an API for requesting a given shipping service. Such an API may specify one or more operations and corresponding operation signatures (parameters, data types, and the like). It is to be appreciated that an API used by one shipping interface (e.g., shipping interface 252) may differ from another shipping interface (e.g., shipping interface 254). Accordingly, the API adapter 306 maps operations for transforming a given request event message to a shipping service request that conforms to the API of the identified shipping interface.

It is to be appreciated that after operation 710 is performed, the shipping service provider then performs the shipping service (e.g., generate a shipping label) requested by the shipping service request sent in operation 710.

At operation 712, the API adapter 306 may receive a shipping service response to the requested shipping service. For example, a shipping service response may include data representing the results of the performance of the requested shipping service. The results may he data indicating whether the shipping service was successfully performed, data representing requested data (e.g., a shipping label, a shipping rate, a shipping insurance rate, and the like), a confirmation number, or a link to a webpage for further processing (e.g., a webpage to initiate payment for the shipping service), as may be generated by the shipping service provider.

At operation 714, the publisher port 304 may send a response event message to the publisher 114 through the message bus 230. The response event message may include data derived from the shipping service response received by operation 712. The response event message may be generated in accordance to a format specified by the message bus. For example, the response event message may include a shipping response topic (see, e.g., FIG. 6 for example shipping response topics).

At operation 716, the message bus 230 receives the response event message with the results of the request event message. Accordingly, the response event message may then route, at operation 718, the response event message to the publisher based on the publisher having previously subscribed to the topic associated with the response event message.

Accordingly, the method 700 provides a general framework for publishers to request one or more shipping service providers to perform a shipping service by communicating the request through a unified interface.

Example use cases of providing shipping services through a unified shipping interface, as may be provided by the shipping capability 240 of FIG. 2, are now described in greater detail.

### Generating Shipping Labels

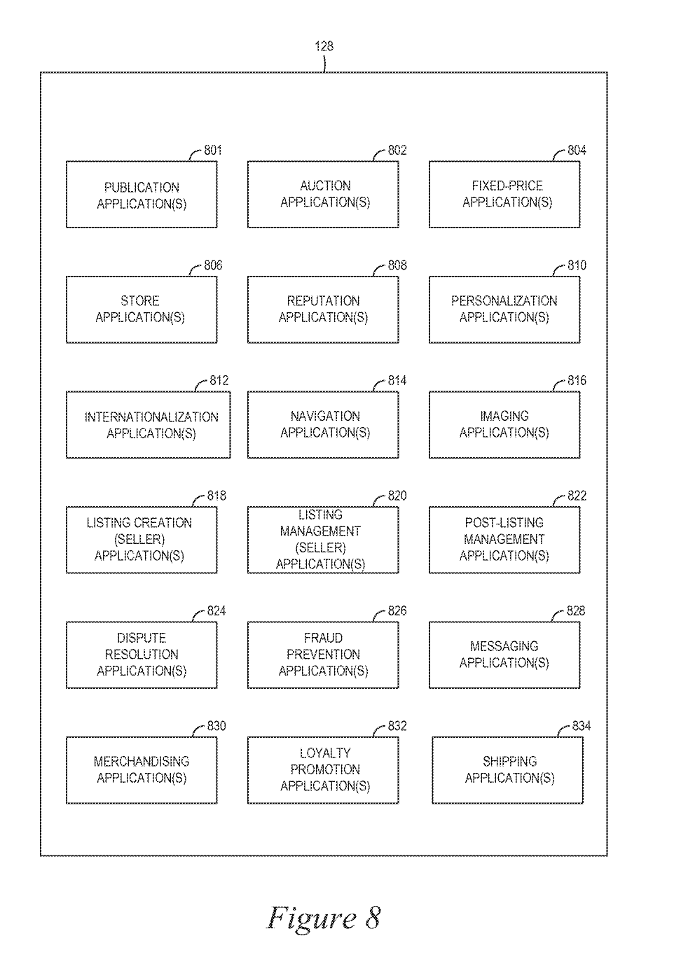

According to example embodiments, the shipping capability 240 shown in FIG. 2, or the shipping application 834 described below with reference to FIG. 8, may be configured to provide a work flow for generating shipping labels. For example, with reference to FIG. 2, a first user (e.g., a merchant) may utilize the publisher 112 to list items (e.g., handmade shirts) for sale. MAGENTO™ is an example of a publisher that a first user may use to sell items. In time, a second user (e.g., a buyer) may initiate a transaction with the first user by using the publisher 112 to purchase one of the items for sale. To ship the purchased item to the second user, the first user may then visit a user interface (e.g., an Admin Page) provided by the publisher 112 that provides and displays details of the order initiated by the second user. After the first user selects an option to ship the order, the first user may make a selection of a shipping service provider to perform the actual shipment (e.g., a shipping service provider, such as FEDEX®).

Clicking a “Print Label” user interface element (a button) may cause the publisher 112 to send a request event message to the message bus 230 with shipping data related to information related to the purchased item, the first and/or second user, and the shipping service provider. The format of the request event message may be generated according to the unified interface provided by the shipping capability 240, irrespective of the shipping service provider selected by the first user. Thus, whether the first user selected to generate Unites States Postal Service (USPS) labels for shipping within US or international shipping labels to ship from China to the United States, the request event message sent to the message bus 230 conforms only with the unified interface of the shipping capability 240.

Once the shipping capability 240 receives the event message through the unified interface, the shipping capability 240 may then generate a new message with a format that conforms to the shipping interface provided by a shipping service provider. In some cases, the shipping capability 240 may perform the requested action (e.g., such as generating a shipping label) on behalf of a shipping service provider. Such may be the case when the shipping service provider does not provide a shipping interface to perform the requested function. The shipping service provider then sends the generated shipping label to the shipping capability 240. In turn, the shipping capability 240 sends the generated shipping label to the network-based publisher through message bus 230.

In some embodiments, before the shipping service provider generates a shipping label, the shipping capability 240 may redirect the publisher 112 to a payment interface. Once the shipping capability 240 receives notification that the first user has made payment for the shipping label, the shipping capability 240 may direct the shipping service provider to generate the shipping label.

### Providing Shipping Insurance

According to example embodiments, the shipping capability 240 shown in FIG. 2, or the shipping application 834 described below with reference to FIG. 8, may be configured to provide a work flow for providing shipping insurance. For example, with reference to FIG. 2, a first user (e.g., a merchant) may utilize the publisher 112 to list items (e.g., handmade shirts) for sale. MAGENTO™ is an example of a network based publisher that a first user may use to sell items. In time, a second user (e.g., a buyer) may initiate a transaction with the first user by using the publisher 112 to purchase one of the items for sale. To purchase shipping insurance to cover the shipment of the purchased item to the second user, the first user may then visit a user interface provided by the publisher 112 (e.g., an Admin Page) that then displays details of the order initiated by the second user. After the first user selects an option to purchase shipping insurance (e.g., SHIP COVER™), the first user may make a selection of an insurance option that fits his needs, as may be offered by a shipping service provider. Clicking a “Purchase Insurance” user interface element may cause the first publisher to send an event message to the message bus 230 with shipping data related to information related to the purchased item, the first and/or second user, and the shipping service provider. The format of the event message may be generated according to the unified interface provided by the shipping capability 240, irrespective of the shipping service provider selected by the first user.

Once the shipping capability 240 receives the event message through the unified interface, the shipping capability 240 may then generate a new message with a format that conforms to the shipping interface provided by a shipping service provider. In some cases, the shipping capability 240 may perform the requested action (e.g., generating an insurance policy that is associated with the order) on behalf of a shipping service provider. Such may be the case when the shipping service provider does not provide a shipping interface to perform the requested function. The shipping service provider then sends the generated insurance policy to the shipping capability 240. In turn, the shipping capability 240 then sends the generated insurance policy to the network-based publisher through message bus 230.

### Shipment Tracking

According to example embodiments, the shipping capability 240 shown in FIG. 2, or the shipping application 834 described below with reference to FIG. 8, may be configured to provide a work flow for tracking data related to the shipment of orders. For example, a first user (e.g., a merchant) may utilize the network based publisher 112 to ship in an order initiated by a second user (e.g., a buyer). Such a shipment workflow is described above. After an item has been shipped, the first or second user may then visit a user interface (e.g., an Admin Page) provided by the publisher 112, which displays details of the order initiated by the second user. In some embodiments, the first or second user may then select an option to track the purchased item (e.g., as may be offered by a shipping service provider such as PITNEY BOWES™). Clicking a “Track Order” user interface element may cause the publisher 112 to send an event message to the message bus 230 with shipping data related to information related to the purchased item, the first and/or second user, the shipping service provider, and confirmation number. The format of the event message may be generated according to the unified interface provided by the shipping capability 240, irrespective of the shipping service provider selected by the first user.

Once the shipping capability 240 receives the event message through the unified interface, the shipping capability 240 may then generate a new message with a format that conforms to the shipping interface provided by a shipping service provider. In some cases, the shipping capability 240 may perform the requested action (e.g., retrieving tracking data related to the shipment of the order) on behalf of a shipping service provider. Such may be the case when the shipping service provider does not provide a shipping interface to perform the requested function. The shipping service provider then sends the tracking data to the shipping capability 240. In turn, the shipping capability 240 then sends the tracking data to the network-based publisher through message bus 230.

### Returns

According to example embodiments, the shipping capability 240 shown in FIG. 2, or the shipping application 834 described below with reference to FIG. 8, may be configured to provide a work flow for returning a purchased item. For example, a first user (e.g., a merchant) may utilize the publisher 112 to sell an item to a second user (e.g., a buyer). After an item has been received, the second user may initiate a return transaction with the first user by using the publisher 112. To return an item, the second user may visit a user interface (e.g., a Return Menu Page) provided by the publisher 112 that then displays details of the order initiated by the second user. After the second user selects an option to return a purchased item (e.g., SHIP COVER™), selecting a “Return item” user interface element may cause the publisher 112 to send an event message to the message bus 230 with shipping data related to information related to the purchased item, the first and/or second user, and a shipping service provider. The format of the event message may be generated according to the unified interface provided by the shipping capability 240, irrespective of the shipping service provider used to provide the return shipment.

Once the shipping capability 240 receives the event message through the unified interface, the shipping capability 240 may then generate a new message with a format that conforms to the shipping interface provided by a shipping service provider. In some cases, the shipping capability 240 may perform the requested action (e.g., generating a return shipment label) on behalf of a shipping service provider. Such may be the case when the shipping service provider does not provide a shipping interface to perform the requested function. The shipping service provider then sends return data (e.g., a generated label) to the shipping capability 240. In turn, the shipping capability 240 then sends the return to the network-based publisher through message bus 230.

### Logistics Management

According to example embodiments, the shipping capability 240 shown in FIG. 2, or the shipping application 834 described below with reference to FIG. 8, may be configured to provide a work flow for providing logistic management. For example, when a user sells an item on a marketplace, the shipping capability 240 or the shipping application 834 may coordinate a pickup at a warehousing facility. Other logistics that may be managed include, by way of example and not limitation, aspects related to transportation, inventory, material handling, packaging, and security.

### Payment Integration

in some embodiments, as shown in FIG. 2, the payment capability 250 may be communicatively coupled to the messaging bus 230. The payment capability 250 may be, in some embodiments, a computer-implemented module that provides a web-service for making payments, such as PAYPAL®. Such a web-service may be utilized in making a payment for a shipping label, insurance, or any other suitable shipping service. For example, the shipping capability 240 may receive a request event message requesting a shipping label, or insurance, from the publisher 112 through the message bus 230. In turn, the shipping capability 240 may then send a payment request to the payment capability 250. In some embodiments, the payment request may be an event message communicated through the message bus 240. In other embodiments, the payment request may be an event message received by the publisher 112 and then redirected to the payment capability 240. The payment capability 240 may then return a payment confirmation (e.g., assuming a seller already has a standing agreement with the payment capability) through the message bus 230 to the shipping capability 240. The shipping capability 240 may then cause a shipping service provider (e.g., the shipping service provider 262) to perform the requested shipping service, such as generating a shipping label or insurance.

### Example Applications

FIG. 8 is a block diagram illustrating example applications and/or services which are provided as part of the network based publisher 112. The network based publisher 112 may provide a number of shopping, listing and price-setting, payment, shipping, and social networking mechanisms in which a setter may engage in item transactions, such as for goods or services. The services may be hosted on dedicated or shared server machines (not shown) that are communicatively coupled to enable communications between server machines. The architecture of one such example server machine is provided below. The applications themselves are communicatively coupled (e.g., via appropriate interfaces) to each other and to various data sources, on as to allow information to be passed between the applications or so as to allow the applications to share and access common data.

The transaction system 100 of FIG. 1 may provide a number of publishing, listing, and price-setting mechanisms whereby a setter may list (or publish information concerning) goods or services for sale, a buyer can express interest in or indicate a desire to purchase such goods or services, and a price can be set for a transaction pertaining to the goods or services. To this end, the application server 128 is shown to include at least one publication application 801 and one or more auction applications 802, which support auction-format listing and price setting mechanisms (e.g., English, Dutch, Vickrey, Chinese, Double, Reverse auctions, etc.). The various auction applications 802 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 804 support fixed-price listing formats (e.g., the traditional classified advertisement-type listing or a catalogue listing) and buyout-type listings. Specifically, buyout-type listings (e.g., including the Buy-It-Now (BIN) technology developed by EBAY INC., of San Jose, Calif.) may be offered in conjunction with auction-format listings, and allow a buyer to purchase goods or services, which are also being offered for sale via an auction, for a fixed-price that is typically higher than the starting price of the auction.

Store applications 806 allow a seller to group listings within a “virtual” store, which may be branded and otherwise personalized by and for the seller. Such a virtual store may also offer promotions, incentives, and features that are specific and personalized to a relevant seller.

Reputation applications 808 allow users that transact, utilizing the transaction system 100, to establish, build, and maintain reputations, which may be made available and published to potential trading partners. Consider that where, for example, the transaction system 100 supports person-to-person trading, users may otherwise have no history or other reference information whereby the trustworthiness and credibility of potential trading partners may be assessed. The reputation applications 808 allow a user, for example through feedback provided by other transaction partners, to establish a reputation within the transaction system 100 over time. Other potential trading partners may then reference such a reputation for the purposes of assessing credibility and trustworthiness.

Personalization applications 810 allow users of the transaction system 100 to personalize various aspects of their interactions with the networked system 100. For example a user may, utilizing an appropriate personalization application 810, create a personalized reference page at which information regarding transactions to which the user is (or has been) a party may be viewed. Further, a personalization application 810 may enable a user to personalize listings and other aspects of their interactions with the transaction system 100 and other parties.

The transaction system 100 may support a number of marketplaces that are customized, for example, for specific geographic regions. A version of the transaction system 100 may be customized for the United Kingdom, whereas another version of the transaction system 100 may be customized for the United States. Each of these versions may operate as an independent marketplace, or may be customized (or internationalized) presentations of a common underlying marketplace. The transaction system 100 may accordingly include a number of internationalization applications 812 that customize information (and/or the presentation of information) by the transaction system 100 according to predetermined criteria (e.g., geographic, demographic or marketplace criteria). For example, the internationalization applications 812 may be used to support the customization of information for a number of regional websites that are operated by the transaction system 100 and that are accessible via respective web servers.

Navigation of the transaction system 100 may be facilitated by one or more navigation applications 814. For example, a search application (as an example of a navigation application) may enable key word searches of listings published via the transaction system 100. A browse application may allow users to browse various category, catalogue, or inventory data structures according to which listings may be classified within the transaction system 100. Various other navigation applications may be provided to supplement the search and browsing applications.

In order to make listings, available via the transaction system 100, as visually informing and attractive as possible, the transaction system 100 may include one or more imaging applications 816 which users may utilize to upload images for inclusion within listings. The imaging application 816 also operates to incorporate images within viewed listings. The imaging applications 816 may also support one or more promotional features, such as image galleries that are presented to potential buyers. For example, sellers may pay an additional fee to have an image included within a gallery of images for promoted items.

Listing creation applications 818 allow sellers to conveniently author listings pertaining to goods or services that they wish to transact via the networked system 100, and listing management applications 820 allow sellers to manage such listings. Specifically, where a particular seller has authored and/or published a large number of listings, the management of such listings may present a challenge. The listing management applications 820 provide a number of features (e.g., auto-relisting, inventory level monitors, etc.) to assist the seller in managing such listings. One or more post-listing management applications 822 also assist sellers with a number of activities that typically occur post-listing. For example, upon completion of an auction facilitated by one or more auction applications 802, a seller may wish to leave feedback regarding a particular buyer. To this end, a post-listing management application 822 may provide an interface to one or more reputation applications 808, on as to allow the seller to conveniently provide feedback regarding multiple buyers to the reputation applications 808.

Dispute resolution applications 824 provide mechanisms whereby disputes arising between transacting parties may be resolved. For example, the dispute resolution applications 824 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 826 implement fraud detection and prevention mechanisms to reduce the occurrence of fraud within the transaction system 100.

Messaging applications 828 are responsible for the generation and delivery of messages to users of the transaction system 100. Such messages, for example, may advise users regarding the status of listings at the transaction system 100 (e.g., providing “outbid” notices to bidders during an auction process or to provide promotional and merchandising information to users). Respective messaging applications 828 may utilize any one of a number of message delivery networks and platforms to deliver messages to users. For example, messaging applications 828 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 830 support various merchandising functions that are made available to sellers to enable sellers to increase sales via the transaction system 100. The merchandising applications 830 also operate the various merchandising features that may be invoked by sellers, and may monitor and track the success of merchandising strategies employed by sellers.

The transaction system 100 itself, or one or more parties that transact via the transaction system 100, may operate loyalty programs that are supported by one or more loyalty/promotions applications 832. For example, a buyer may earn loyalty or promotions points for each transaction established and/or concluded with a particular seller, and be offered a reward for which accumulated loyalty points can be redeemed.

The shipping applications 834 may provide a unified interface to two or more shipping services, as described above. The shipping applications 834 may provide shipping services utilized in connection with ordering an item, returning an item, offering insurance, or the like. In some embodiments, the shipping applications 834 may communicate with one or more external shipping services, or may operate on behalf of the shipping services.

It will be appreciated that one or more of the various example transaction and publication applications 130, 132 may be combined into a single application. Further, in some embodiments, one or more applications may be omitted and additional applications may also be included. Still further, consistent with embodiments described herein, one or more of the transaction and publication applications 130, 132 may form part of a system that communicates event messages through a message bus, as discussed above (See, e.g., FIG. 2).

### Exemplary Computer Systems

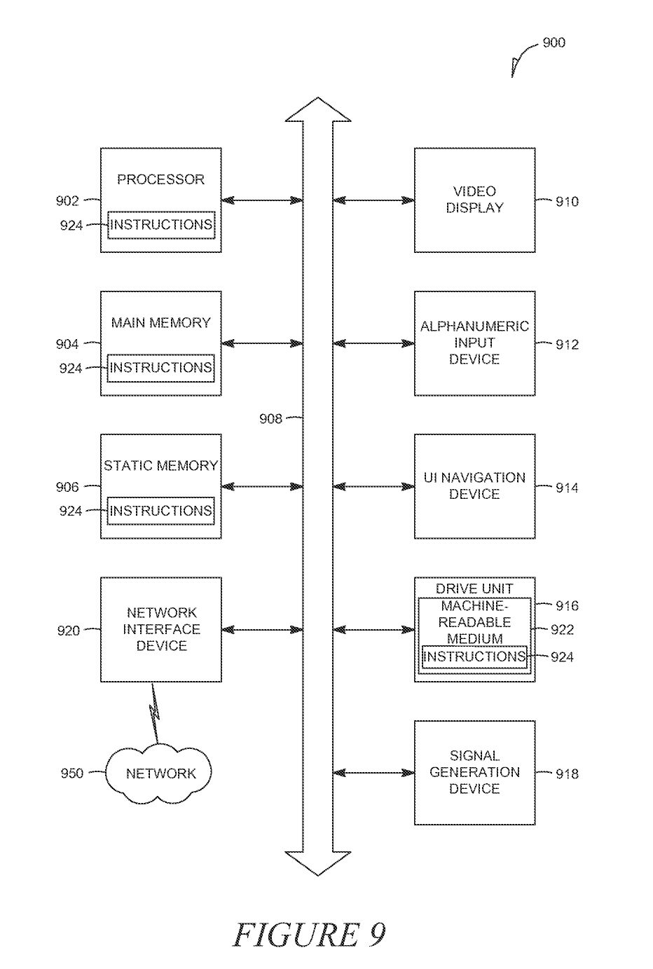

FIG. 9 shows a diagrammatic representation of machine in the example form of a computer system 900 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a UI navigation device 914 (e,g., a mouse), a disk drive unit 916, a signal generation device 918 (e.g., a speaker), and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 950 via the network interface device 920 utilizing any one of a number of well-known transfer protocols (e.g., hypertext transfer protocol (HTTP)).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of discussed herein, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

The Abstract of the Disclosure is provided to comply with 37 C.F.R. §1.72(b), requiring an abstract that will allow the reader to quickly ascertain the nature of the technical disclosure, it is submitted with the understanding that it will not be used to interpret or limit the scope or meaning of the claims. In addition, in the foregoing Detailed Description, it can be seen that various features are grouped together in example embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Furthermore, the following claims are hereby incorporated into the Detailed Description, with each claim standing on its own as a separate embodiment.

What is claimed is:

1. A computer-implemented system configured to provide a publisher with a single interface to a plurality of shipping service providers, the computer-implemented system comprising:
at least one processor;
a listener port implemented by the at least one processor and configured to receive, through a message bus, a request event message sent by the publisher, the request event message comprising a shipping service provider identifier; and
an application program interface (API) adapter implemented by the at least one processor and configured to:
identify a shipping interface based on the shipping service provider identifier, the shipping interface corresponding to a shipping service provider of the plurality of shipping service providers; and
send, using the shipping interface, a shipping service request to the shipping service provider, the shipping service request corresponding to a shipping service provided by the shipping service provider.

2. The system of claim 1, wherein the API adapter is further configured to generate the shipping service request based at least in part on transforming the request event message to a format specified by an application programming interface utilized by the shipping interface.

3. The system of claim 1, wherein the request event message further includes a shipping request topic, and the API adapter is further configured to invoke an operation specified by the shipping interface based on the shipping request topic.

4. The system of claim 3, wherein the shipping request topic corresponds to at least one of: a request to generate a shipping label, a request to calculate a shipping rate, a request to purchase shipping insurance, or a request to return a previously shipped item.

5. The system of claim 1, further comprising a publisher port implemented by the at least one processor and configured to receive a shipping service response that includes a result of performing the shipping service; and
wherein the API adapter is further configured to send a response event message to the publisher, the response event message including data corresponding to the result.

6. The system of claim 1, wherein the listener port is further configured to subscribe to a shipping request topic through the message bus, and the request event message includes the shipping request topic.

7. The system of claim 6, wherein the API adapter is further configured to map the shipping request topic to an operation provided by the shipping service provider interface.

8. The system of claim 6, wherein the API adapter is further configured to:
determine that the shipping request topic is associated with an unsupported operation associated with the shipping service provider interface; and
perform the unsupported operation on behalf of the shipping service provider.

9. The system of claim 8, wherein the unsupported operation generates a shipping label.

10. The system of claim 1, wherein:
the listener port is further configured to receive an additional request event message that comprises a different shipping service provider identifier; and
the API adapter is further configured to:
identify a different shipping interface based on the different shipping service provider identifier, the different shipping interface corresponding to a different shipping service provider of the plurality of shipping service providers; and
send, using the different shipping interface, an additional shipping service request to the different shipping service provider, the additional shipping service request corresponding to a shipping service provided by the different shipping service provider.

11. A computer-implemented method of providing a publisher with a single interface to a plurality of shipping service providers, the computer-implemented method comprising:
receiving, through a message bus, a request event message sent by the publisher, the request event message comprising a shipping service provider identifier;
identifying a shipping interface based on the shipping service provider identifier, the shipping interface corresponding to a shipping service provider of the plurality of shipping service providers; and
sending, using the shipping interface, a shipping service request to the shipping service provider, the shipping service request corresponding to a shipping service provided by the shipping service provider.

12. The computer-implemented method of claim 11, further comprising generating the shipping service request based at least in part on transforming the request event message to a format specified by an application programming interface utilized by the shipping interface.

13. The computer-implemented method of claim 11, further comprising invoking an operation specified by the shipping interface based on a shipping request topic, the request event message further including the shipping request topic,

14. The computer-implemented method of claim 13, wherein the shipping request topic corresponds to at least one of: a request to generate a shipping label, a request to calculate a shipping rate, a request to purchase shipping insurance, or a request to return a previously shipped item.

15. The computer-implemented method of claim 11, further comprising:
receiving a shipping service response that includes a result of performing the shipping service; and
sending a response event message to the publisher, the response event message including data corresponding to the result.

16. The computer-implemented method of claim 11, further comprising subscribing to a shipping request topic through the message bus, wherein the request event message includes the shipping request topic.

17. The computer-implemented method of claim 16, further comprising mapping the shipping request topic to an operation provided by the shipping service provider interface.

18. The computer-implemented method of claim 16, further comprising:
determining that the shipping request topic is associated with an unsupported operation associated with the shipping service provider interface; and
performing the unsupported operation on behalf of the shipping service provider.

19. The system of claim 18, wherein the unsupported operation generates a shipping label.

20. A non-transitory computer-readable medium storing executable instructions thereon, which, when executed by a processor, cause the processor to perform operations including:
receiving, through a message bus, a request event message sent by a publisher, the request event message comprising a shipping service provider identifier;
identifying a shipping interface based on the shipping service provider identifier, the shipping interface corresponding to a shipping service provider of the plurality of shipping service providers; and
sending, using the shipping interface, a shipping service request to the shipping service provider, the shipping service request corresponding to a shipping service provided by the shipping service provider.
